(19) United States
(12) Patent Application Publication
(10) Pub. No.: US 2014/0357342 A1
(43) Pub. Date: Dec. 4, 2014

(54) SYSTEMS AND METHODS FOR REPLACING LOWER VALUE SYMBOLS WITH HIGHER VALUE SYMBOLS IN A GAME

(71) Applicant: Gamesys Ltd., London (GB)

(72) Inventor: Hans Elias, St. Albans (GB)

(73) Assignee: Gamesys Ltd., London (GB)

(21) Appl. No.: 14/295,308

(22) Filed: Jun. 3, 2014

Related U.S. Application Data
(60) Provisional application No. 61/830,198, filed on Jun. 3, 2013.

(51) Int. Cl. G07F 17/32

(52) U.S. Cl. CPC G07F 17/329
USPC 463/20

(57) ABSTRACT

In accordance with some embodiments, systems, methods and articles of manufacture provide for facilitating a game by: (i) determining a plurality of symbols selected for use in at least one game event; (ii) identifying a symbol of the plurality of symbols which corresponds to a highest relative value, thereby determining a replacement symbol; (iii) designating as a default symbol at least one symbol of the plurality of symbols which is not the replacement symbol; (iv) determining an initial outcome for the at least one game event; (v) determining that the initial outcome include at least one default symbol; and (vi) replacing with the replacement symbol each of the at least one default symbols, thereby creating a revised outcome. In one embodiment, the default symbol is the symbol corresponding to the lowest relative value. In one embodiment, the game may be a gambling game (e.g., an online reeled slot machine game).

This application claims the benefit of U.S. Provisional Application No. 61/830,198 filed Jun. 3, 2013 in the name of Hans Elias, titled SYSTEMS AND METHODS FOR REPLACING LOWER VALUE SYMBOLS WITH HIGHER VALUE SYMBOLS IN A GAME. The entirety of this Provisional Application is incorporated by reference herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments described herein relate to electronic games (e.g., games playable over the Internet or other network). In particular, at least some embodiments relate to game in which a first symbol initially appearing as part of an outcome of the game may be replaced by a second symbol, which also initially appears as part of the outcome of the game. In at least one embodiment, the electronic game is a wagering game.

### BRIEF DESCRIPTION OF THE FIGURES

FIG. 1 is a schematic diagram of an embodiment of a gaming system in accordance with one or more embodiments described herein.

FIG. 2 is a schematic diagram of an embodiment of a social gaming platform in accordance with one or more embodiments described herein.

FIG. 3 is a block diagram of an embodiment of a computing device useful in a system according to one or more embodiments described herein.

FIG. 4 comprises a table illustrating one embodiment of an example payout schedule.

FIG. 5A comprises one example embodiment of a game interface (e.g., a screen shot of an online game) for facilitating a game, via which a player may provide input regarding a selection set of symbols for use in a game, in a manner consistent with one or more embodiments described herein.

FIG. 5B comprises an example embodiment of a game interface (e.g., a screen shot of an online game) for facilitating a game, via which the selection set of symbols selected by the player is revealed to the player, in a manner consistent with one or more embodiments described herein.

FIG. 6A comprises an example embodiment of a game interface (e.g., a screen shot of an online game) for facilitating a game, via which an initial outcome may be output, in a manner consistent with one or more embodiments described herein.

FIG. 6B comprises an example embodiment of a game interface (e.g., a screen shot of an online game) for facilitating a game, via which revised outcome may be output, in a manner consistent with one or more embodiments described herein.

FIG. 7 is a flowchart of an example process consistent with one or more embodiments described herein.

### DETAILED DESCRIPTION OF EXAMPLE EMBODIMENTS

Applicants have recognized that there is a continuing need for new ways of making games more exciting, to maintain player interest in such games and to provide additional reward opportunities within the games. In particular, Applicants are focused on improving games which utilize a plurality of symbols which form outcomes, particularly games in which different symbols may correspond to different values.

Although the embodiments described herein are not limited to implementations in “reel-type” or reeled slot machine games, they are applicable to such games. A reel-type of slot machine game, whether deployed on a dedicated gaming device (e.g., a traditional slot machine device in a casino, operable primarily to facilitate one or more slot machine games) or on a non-dedicated computing device (e.g., personal computers, mobile devices, laptops or table computers, which are operable to perform a variety of functions in addition to supporting reeled slot machine games) are popular with many players. A reeled slot machine game typically includes a plurality of reels, each reel including a plurality of symbol positions for display of a reel symbol. A reel symbol is a visual representation of an element or indicia used in the game to determine whether the player qualifies for an award. The reel may be mechanical (e.g., in a physical dedicated gaming device on a casino floor) or virtual (e.g., a software representation of a reel on an electronic display of a dedicated or non-dedicated device). The reels spin (or representations of virtual reels which are made to look as if they spin) upon a player placing a wager on the game or providing another qualifying input. The reels then stop to display generated combinations of symbols on the reels.

A “symbol” (e.g., a reel symbol), as the term is used herein unless indicated otherwise, is a representation or element of a game which functions in the game to indicate an outcome and/or result of the game (e.g., in combination with other symbols). In accordance with some embodiments, a plurality of symbols in a game is combined or output as a representation of an outcome. The “outcome” of a game event (e.g., a spin of a reel-type game), as the term is used herein, is the set of symbols as displayed in a predetermined position (e.g., along one or more symbol positions of a plurality of reels which together comprise a payline of the game) to indicate a result of a game event (e.g., whether the player has won a payout or other prize and the magnitude of the payout or prize won, which may be determined in conjunction with a payout table which indicates the outcomes that correspond to payout amounts or other prizes). In a card game, a card or virtual representation of a card may be considered a symbol of the game. In a dice game, a face of a die (illustrating the number of dots or other elements represented on the die) may be considered a symbol of a game.

Thus, a symbol may be considered to be a component of an outcome. If a generated symbol or combination of symbols is a winning symbol or combination of symbols (i.e., a symbol or combination of symbols is associated with an award), the player typically receives that award when the generated symbol or combination of symbols appears, at the resolution or final output of a game result, in a predetermined area of a game interface or in an otherwise qualifying manner. For example, in a reeled slot machine game, the award for a winning combination of symbols may be provided if the combination of symbols appears along an active payline associated with the reels or in a scatter pay. An outcome which corresponds to a payout or reward is referred to herein as a winning outcome. The symbols along a given payline at the end of a spin (i.e., once the reels are stopped and the symbols in the symbol positions are positioned such that a player may determine whether he/she qualifies for an award as a result of the spin) are referred to, with respect to the given payline, as the “outcome of the payline” herein. Thus, an outcome of a game event (e.g., spin of a reeled slot machine game, final hand of a card game) may comprise one or more outcomes of paylines. If the outcome of the payline corresponds to a payout or other reward, it is a winning outcome. A payline may be in the form of a line that crosses through one symbol position on each of a plurality of reels, along which the symbols are evaluated to determine whether they form a winning combination. Paylines may be of various shapes (horizontal, vertical, oblique, triangular, trapeziodal, zigzag, etc.), may or may not be formed with contiguous or adjacent symbol positions, etc. The embodiments described herein are not reliant on any particular payline configuration.

Described herein are features and game mechanics which are applicable to any game (e.g., a reeled slot machine type of game) in which payouts, prizes or rewards are awarded for certain pre-determined combinations of symbols appearing along paylines or in one or more predetermined location(s) of the game. Although embodiments are described with reference to a reeled slot machine game, the embodiments are not limited to these types of games. For example, at least some embodiments described herein are applicable to a card game in which symbols comprising an outcome are output as a group of cards forming a hand or other result in a card game. In another example, at least some embodiments described herein are applicable to a dice game in which game symbols comprise virtual dice which are “rolled” in a virtual area of a board game or other type of dice game.

In accordance with some embodiments, systems, methods and articles of manufacture (e.g., non-transitory computer readable media) provide for facilitating a game by (i) identifying at least one replacement symbol for use in at least one game event (e.g., the replacement symbol being the highest valued symbol in a set of symbols selected by a player or randomly selected for use in the game); (ii) identifying at least one default symbol to be replaced by the replacement symbol in the at least one game event (e.g., the remainder of the symbol(s) in the set of symbols selected by a player or randomly selected for use in the game are designated as the default symbol(s)); (iii) determining an initial outcome for the game event; (iv) determining that the initial outcome includes the at least one default symbol; (v) replacing the at least one default symbol with the replacement symbol, thereby creating a revised outcome; and (vi) providing any payout which may correspond to the revised outcome.

In accordance with some embodiments, systems, methods and articles of manufacture provide for facilitating a game by (i) identifying, for use in at least one game event, a plurality of symbols comprising a selection set (e.g., the selection set being selected by a player or randomly determined for use in the at least one game event); (ii) identifying the symbol of the selection set which corresponds to the highest relative value, thereby identifying a replacement symbol; (iii) designating at least symbol of the selection set other than the replacement symbol (e.g., the lowest valued symbol or each of the other symbols) as a default symbol; (iv) determining an initial outcome for the game event; (v) replacing each default symbol included in the initial outcome with the replacement symbol, thereby creating a revised outcome; (vi) evaluating the revised outcome to determine whether the revised outcome corresponds to a payout; and (vii) only if the revised outcome corresponds to the payout, authorizing the payout to be provided to a player of the game.

In accordance with some embodiments, systems, methods and articles of manufacture (e.g., non-transitory computer readable media) provide for facilitating a game by (i) determining a plurality of symbols selected by a player; (ii) determining, for each symbol of the plurality of symbols selected by the player, a corresponding value; (iii) identifying the symbol of the plurality of symbols which corresponds to a highest relative value, thereby determining a highest value symbol; (iv) determining, for a round of a game in which the plurality of symbols are used, an outcome of the spin; (v) determining whether any of the symbols of the plurality of symbols are included in the outcome; and (vi) replacing each of the symbols of the plurality of symbols which is included in the outcome and which is not the highest value symbol with the highest value symbol.

In accordance with some embodiments involving a reeled slot machine game, one or more symbols on a particular reel (or one or more symbols in particular symbol positions visible to a player of a game interface on which the reels are displayed a player of the game or which symbols are otherwise output to a player of the game) are replaced with replacement symbols if a predetermined qualifying event is determined to have occurred in the game.

The term “replacement symbol” as the term is used herein unless indicated otherwise, refers to a symbol which (e.g., for purposes of a particular spin, round, game event or game instance of a game) replaces another symbol which would otherwise appear in the relevant symbol position. In accordance with one embodiment, a replacement symbol is a symbol associated with a higher value than is the symbol which is being replaced. The symbol that is replaced with a replacement symbol is referred to herein as the “default symbol.”

In accordance with one embodiment, the replacement feature is applied to a subset of symbols of the game (referred to as a “selection set” herein), such that the selection set of symbols is first determined and the replacement symbol(s) is determined to be the symbol within the selection set which is associated with the highest value. In accordance with one embodiment, the symbol of the selection set which is associated with the lowest relative value (relative to the other symbols in the selection set) is designated as the default symbol. In accordance with another embodiment, each symbol of the selection set other than the replacement symbol is designated as a default symbol.

In one embodiment, the selection set may comprise a set of symbols selected by a player of the game. For example, a set of symbols selected by a player are identified, the highest valued symbol of the set is identified (e.g., designated as the replacement symbol), and the other symbols in the set are designated as the default symbols and replaced with the highest value symbol upon the occurrence of a predetermined event, such as if any of the default symbols of the set appear as part of an outcome (e.g., a winning outcome) of the game. In one embodiments, the selection set of symbols and replacement feature utilizing a particular selection set of symbols is active for a predetermined time, predetermined number of game events and/or only within a predetermined aspect of the game (e.g., within a bonus round of the game). Thus, for example, a player may be prompted to select a plurality of symbols as a selection set upon a bonus round of a game being initiated and the selection set selected by the player may be active as a selection set for the duration of that bonus round (e.g., for all spins in a free spins bonus). In another example embodiment, a set of symbols may be designated as a selection set (with the highest-value symbol(s) of the selection set being designated as a replacement symbol(s) and the remaining symbols being designated as default symbols), whether by the player or by a processor (e.g., on a random or other basis), for a predetermined duration of time or game events or until a termination event occurs (a termination event being a game event which terminates the replacement feature described herein). In one embodiment, the selection set may be selected for a single game event (e.g., for a single spin of a reeled slot machine game). In one embodiment, the selection set may be persistent for a player over more than one session of the game.

In many games individual symbols, even if they do not in themselves correspond to a payout or reward, may be associated with a value or relative value. Such values may or may not be known or discernable to a player. In some embodiments, such values may be ascribed to symbols specifically for purposes of implementing the replacement feature described herein while in other embodiments symbols may already be associated with respective values for other purposes or goals of the game.

A value of a symbol may be determined based on a variety of factors and the embodiments described herein are not dependent on any particular scheme or methodology of valuing symbols. For example, a value may be assigned or determined for a particular symbol based on how many winning outcomes the symbol is a component of and/or the relative value of a payout or other prize associated with the one or more winning outcomes the symbol is a component of. Consider the following example of a pay table for a fruit-themed slot machine:

TABLE 1
Example Payout Schedule for Fruit Themed Slot Machine Game

| Payline Outcome | Payout (in credits) |
|---|---|
| Bar-bar-bar | 100 |
| Plum-plum-plum | 50 |
| Bell-bell-bell | 20 |
| Orange-orange-orange | 15 |
| Cherry-cherry-cherry | 10 |
| Cherry-cherry-any | 5 |
| Cherry-any-any | 2 |

Assume, for purposes of the present embodiment, the possible symbols for this fruit-themed game are (i) bar, (ii) plum, (iii) bell, (iv) orange, (v) cherry, and (vi) banana. Assume further that, in the present non-limiting example, a higher value symbol is associated with a larger number representing the value while a lower value symbol is associated with a relatively smaller number representing the relatively lower value (of course any value representation scheme which represents relative differences in value may be employed and the embodiments described herein are not limited to any particular value representation scheme). As can be appreciated from the table above, the symbol “banana” is not a component of any winning outcome. Thus, in some embodiments the symbol “banana” may be associated with a relatively low value (e.g., a value of one (1)). The symbol “bar”, on the other hand, is a component of the highest paying winning outcome. Thus, the symbol “bar” may be associated with a relatively high value (e.g., a value of five (5)). The symbol “bell” is associated with the second highest paying winning outcome and may therefore, for purposes of the present non-limiting example, be associated with a value of four (4). The symbol “orange”, although associated with the third highest winning payout, may not necessarily be associated with the next lowest value of three (3). For example, in some embodiments the value of a symbol may be determined based on various factors. One of these factors may be the value of the payout or other prize associated with the winning outcome of which the symbol is a component. However, another factor may be the number of winning outcomes of which the particular symbol is a component. For example, in the payout schedule illustrated in Table 1 above, the symbol “orange” only appears in one winning outcome while the symbol “cherry” appears in three winning outcomes (albeit smaller value payouts). Thus, in some embodiments the symbol “cherry” may be assigned a value of three (3) while the symbol “orange” may be associated with a value of two (2).

Thus, in accordance with some embodiments, a value may be assigned to one or more symbols available in a particular game (e.g., each symbol available in the game). The value may be determined based on one or more factors, such as: (i) the relative value of the payout or prize of winning outcomes of which the symbol is a component; (ii) the number of winning outcomes of which the symbol is a component; (iii) the distribution of the symbol among the reels of the game (e.g., how many times the symbol appears on one or more of the reels); (iv) any bonus awards or events which may be triggered or impacted by the appearance of the symbol along one or more paylines; and (v) data associated with the player (e.g., personalized data of the player, such as achievements or preferences of the player in the present or previous games).

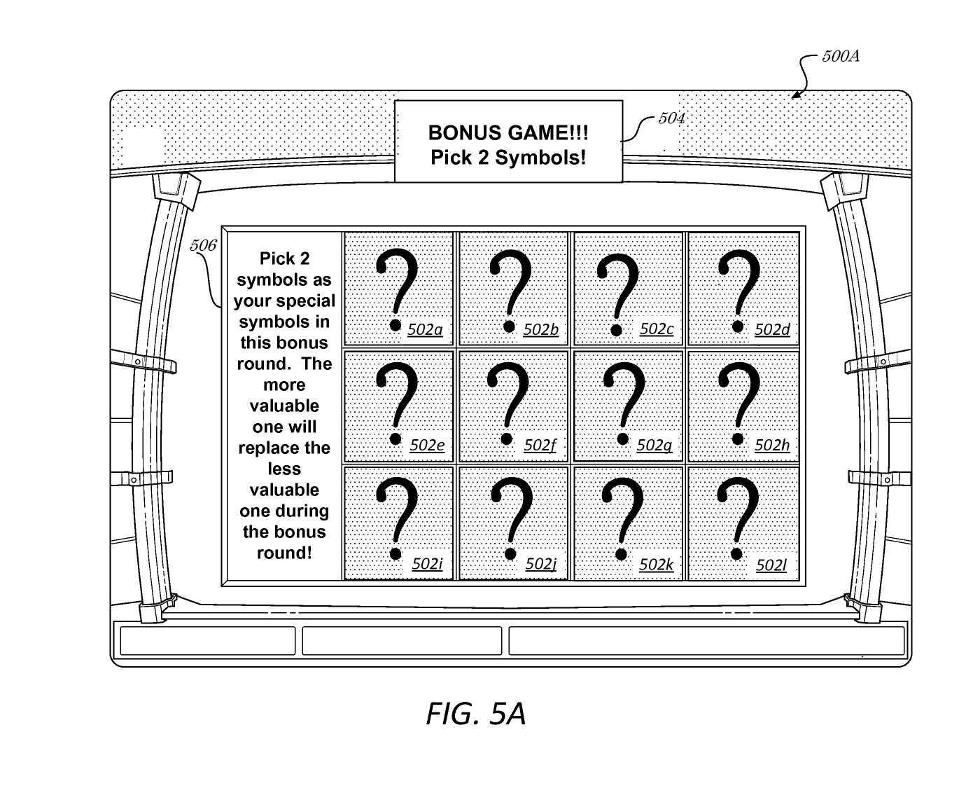

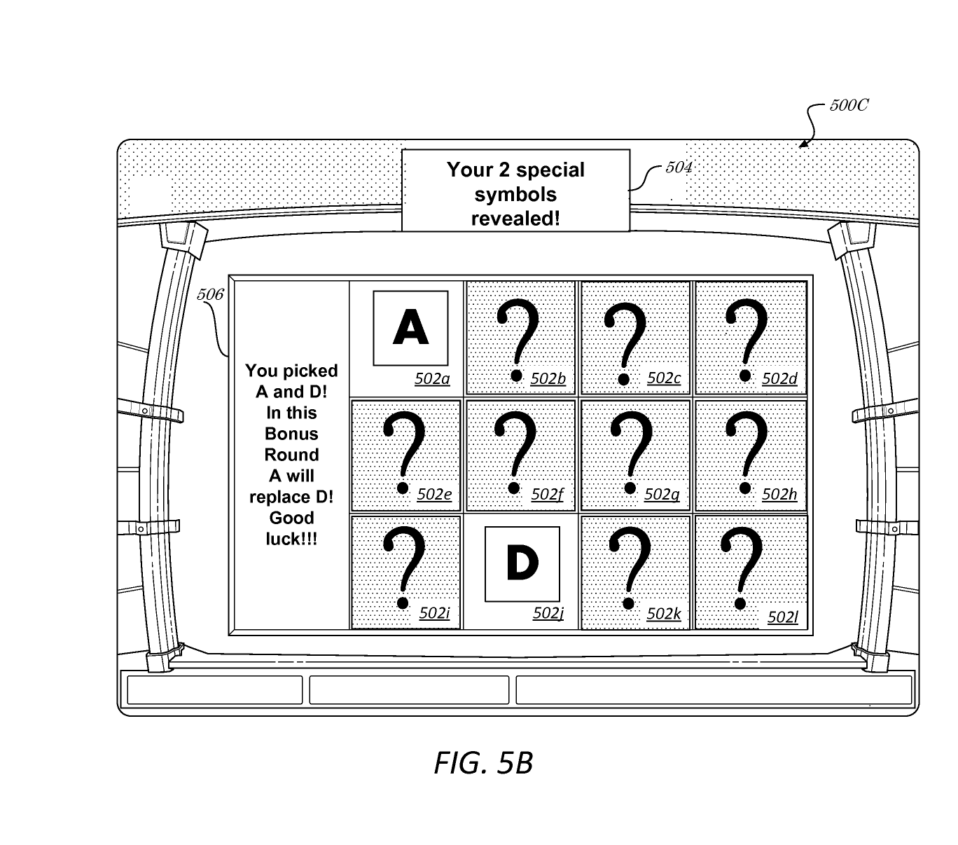

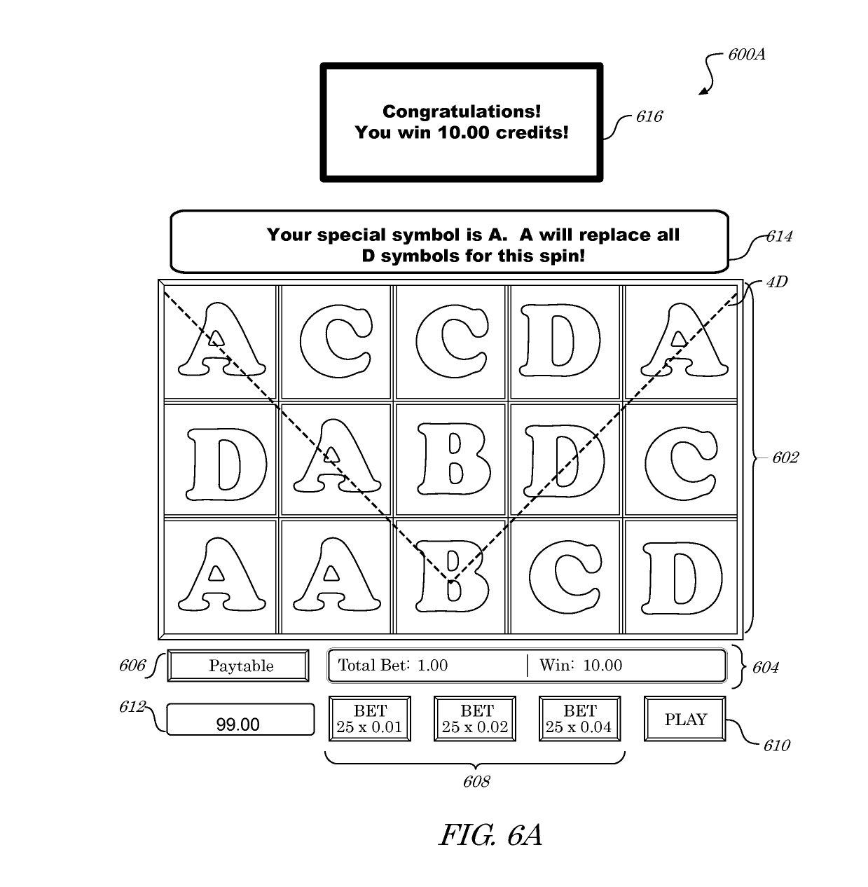

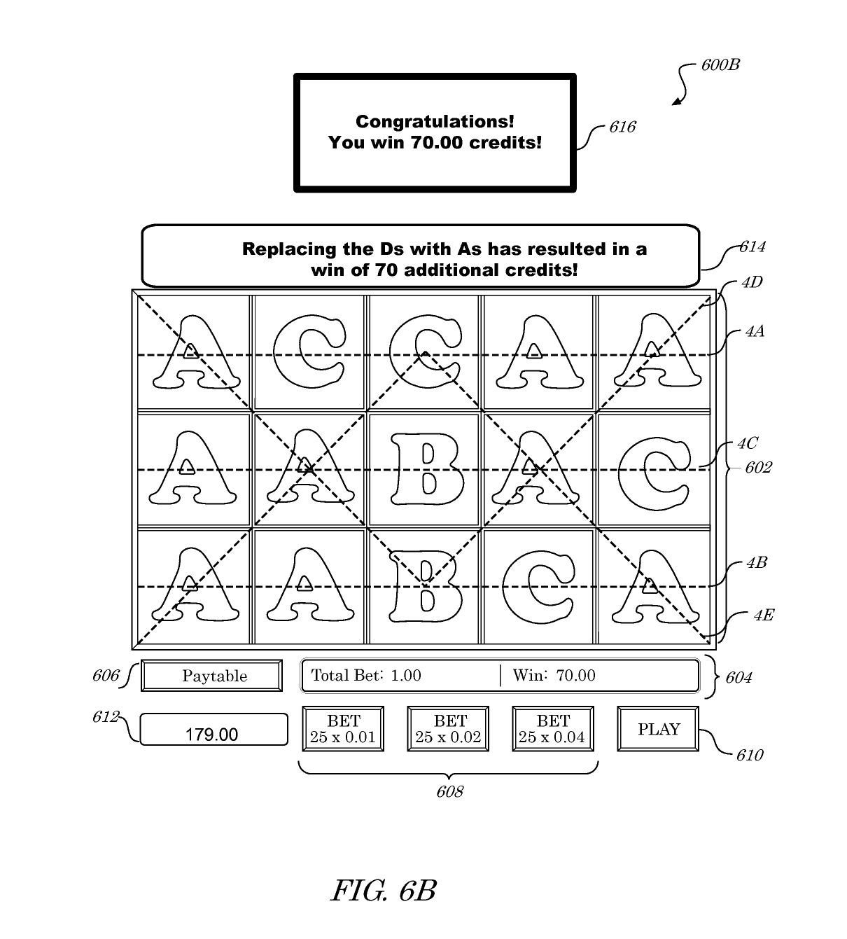

Table 2 below illustrated one example scheme in which a predetermined value (however it is determined) is assigned to each symbol of a game in which the available symbols are “A”, “B”, “C”, “D”, “E”, “F”, “G”, “H”, “I” and “J.” In the scheme of Table 2, a higher numerical value indicates a more valuable symbol. As can be appreciated from the data in the table, A is the most valuable symbol and C is the least valuable symbol. The embodiments described herein with reference to FIGS. 5A, 5B, 6A and 6B refer to the example data of Table 2, for purposes of illustrating one example implementation of a reeled slot machine game which utilizes the symbols A-J and the replacement feature described herein.

TABLE 2
Example Values for Symbols in an Illustrative Game

| Symbol | A | B | C | D | E | F | G | H | I | J |
|---|---|---|---|---|---|---|---|---|---|---|
| Value | 4 | 3 | 1 | 2 | 7 | 9 | 6 | 5 | 8 | 10 |

Although Table 2 illustrates one example embodiment in which symbols available in a game correspond to static, predetermined values (which may be determined or assigned based on any desirable factors), in accordance with some embodiments a value of a symbol may change or fluctuate based on conditions or circumstances of the game in which it is output. For example, in a game which has a collection feature (e.g., as part of a secondary feature of a game, a player may win a prize if he collects a predetermined number of a certain symbol, wherein a symbol may be considered to be collected by the player if it appears as a final outcome based upon which a payout is determined). In such a game, a symbol which may otherwise be associated with a low value may be considered to have a relatively higher value if it is a symbol that is being collected and/or in a circumstance in which the player is close to collecting the predetermined number of the symbol. Accordingly, in some embodiments a value of a symbol may be determined anew (or modified) from one game event to another (e.g., from one spin to another in a reeled slot machine game). This may impact the replacement feature described herein. For example, in a selection set of symbols a first symbol may be considered to be the highest value symbol (and thus the replacement symbol) in a first spin of a bonus round but a second symbol may be considered to be the highest value symbol (and thus the replacement symbol) in a second spin of the bonus round. Thus, in some embodiments, the determination of which symbol of a selection set of symbols is designated as the replacement symbol may be performed upon each game event in which the replacement symbol is to be utilized (e.g., upon each spin). In other embodiments, one particular symbol of a selection set may be designated as a replacement symbol when the selection set is first selected (e.g., based on static values corresponding to each of the symbols in the selection set) and designated as the replacement symbol for all game events in which that particular selection set is applied.

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., a slot machine in a brick-and-mortar casino). “Gaming” thus refers to play of a game. A game may refer to any of a casual game, a wagering game and/or a social network game.

A “casual game”, as the term is used herein unless specified otherwise, may comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein unless specified otherwise, refers to a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

A “session” comprises a period of time spanning a plurality of event instances, game instances, spins or turns of a game, the session having a defined start and defined end. An “event instance”, “game instance”, “session” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game. Accordingly, a session may refer to a session of a primary game or a session of a bonus round, mode or feature of the game, depending on the context.

An “outcome” should be differentiated from a “result” in the present description in that an “outcome” is a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass prizes which may comprise awards, payouts, discounts, eligibility, advancement in a game or other benefits (whether monetary or non-monetary, tangible or intangible) to a player and that any reference to a “prize”, “award” or “payout” may refer to any or all of the foregoing, unless the context explicitly indicates otherwise.

A “bonus round”, “bonus mode” or “bonus feature” of a game, as the terms are used interchangeably herein unless indicated otherwise, may refer to a secondary game, entry into which is triggered via one or more events which may occur in a base or primary game. Typically, a player may be able to qualify to play a bonus game based on one or more outcomes in a primary game, such as in a basic mode or a qualifying mode. A bonus round may be played in accordance with a set of rules that is different from those of a primary game, and may be accompanied by displays, colors, sounds, animated sequences, game play and/or prizes that are not part of the primary game. In one embodiment, a primary or base game application or program may include programming or instructions which will automatically begin a bonus round after the player has achieved a triggering event or qualifying condition in the base or primary game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

### I. DESCRIPTION OF FIGURES

### Example Systems

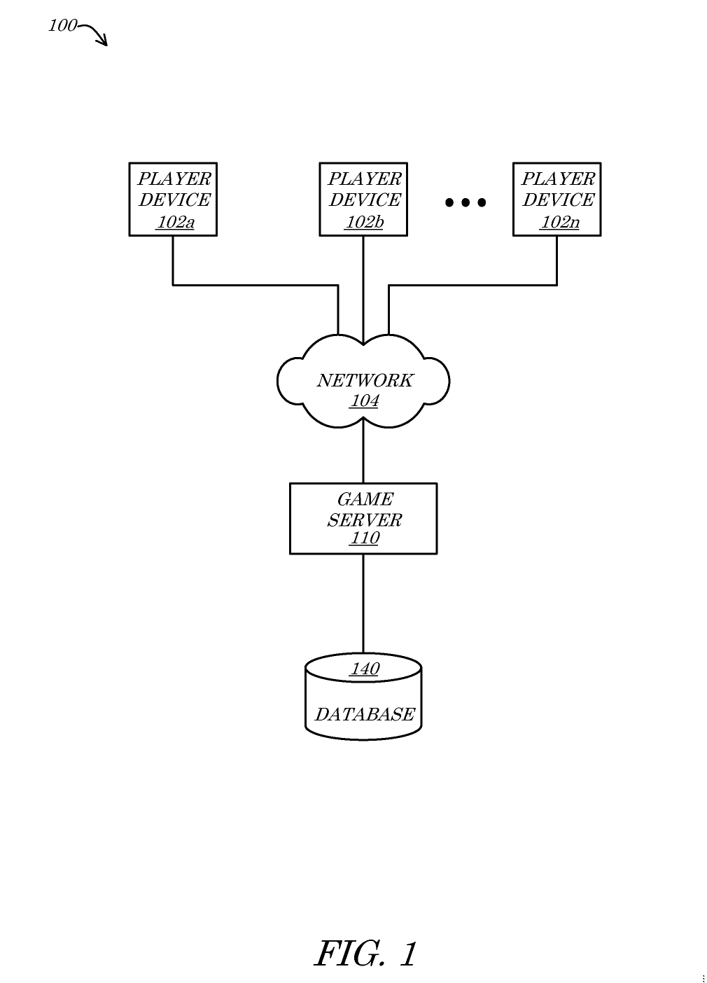

Referring now to the figures, FIG. 1 depicts a block diagram of an example system 100 according to some embodiments. The system 100 may comprise a plurality of player devices 102a-102n in communication with a game server 110 via a network 104. For purposes of brevity, any or all of the player devices 102a-102n will be referred to as a player device 102 herein, even though the plurality of player devices 102a-102n may include different types of player devices (as described below). The game server 110 may also be operable to communicate with or access a database 140 (which may comprise one or more databases and/or tables and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts.

In some embodiments a game server 110 and/or one or more of the player devices 102 stores and/or has access to data useful for facilitating play of a game. For example, game server 110 and/or a player device 102 may store (i) one or more probability databases for determining one or more outcome(s) for an event instance, spin or turn of a game, (ii) a current state or status of a game or game session (e.g., a selection set, replacement symbol and/or default symbol(s) for use in one or more game instances of a game or game session of a particular player), (iii) one or more user interfaces for use in a game, (iv) one or more game themes for a game and/or (v) profiles or other personal information associated with a player of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

A game server 110 may comprise a computing device for facilitating play of a game (e.g., by receiving an input from a player, determining an initial outcome for a game, causing an outcome of a game to be displayed on a player device, determining a selection set for a game, determining a value for a symbol in a selection set, determining whether to replace a default symbol with a replacement symbol, determining a revised outcome, facilitating a wager and/or a provision of a payout for a game). For example, the game server 110 may comprise a server computer operated by a game provider or another entity (e.g., a social network website not primarily directed at providing games). In some embodiments, the game server may determine an outcome for spin of a game by requesting and receiving such an outcome from another remote server operable to provide such outcomes. In some embodiments, the game server 110 may further be operable to facilitate a game program for a game (e.g., a wagering game). In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator).

Examples of processes that may be performed by the game server 110 (directly or indirectly) may include, but are not limited to: (i) determining an initial outcome (i.e., an outcome prior to any replacing of symbols) for a player; (ii) determining whether the initial outcome includes any default symbols to be used in the game; (iii) replacing default symbols with a replacement symbol to create a revised outcome; (iv) determining a selection set for one or more game instances of a game (e.g., determining values for each of the symbols in a selection set and designating the highest valued symbol as the replacement symbol and the remaining symbol(s) as default symbol(s)); (v) re-evaluating one or more paylines of the game for any winning symbol combinations created as a result of any replacing of symbols; (vi) transmitting an indication of outcomes to a player device; (vii) authorizing a game program to be downloaded to a player device; and/or (viii) modifying (or directing a player device to modify) a game interface which is outputting an outcome of a payline to reflect any replacing of symbols.

Turning now to a description of a player device 102, in accordance with some embodiments a player device 102 may comprise a computing device that is operable to execute or facilitate the execution of a game program and used or useful by an online player for accessing an online casino or other electronic (e.g., online) game provider. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox 360™, Sony™ Plasystation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). It should be noted that a game server 110 may be in communication with a variety of different types of player devices 102. In some embodiments, a player device may comprise a dongle or other computing device which does not include an input or output device but is operable to be plugged into another device (e.g., a television, set-top box or other computing device) and be operable to receive input of information and output information via components of the other device.

A player device 102 may be used to play a wagering or non-wagering game (e.g., a social or casual game) over a network and output information relating to the game to players participating in the game (e.g., outcomes for an event instance of the game, qualifying for a bonus round of the game, credit balance of credits available for play of the game, a session result for a session of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In another embodiment, a player device 102 may store some or all of the program instructions for determining, for example, (i) that an event instance has been triggered or initiated (and, in some embodiments, communicating such a trigger or initiation to game server 110), (ii) an initial outcome and/or result of the game; (iii) a revised outcome and/or result, and/or (iv) determining a session result.

In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110. It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102.

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

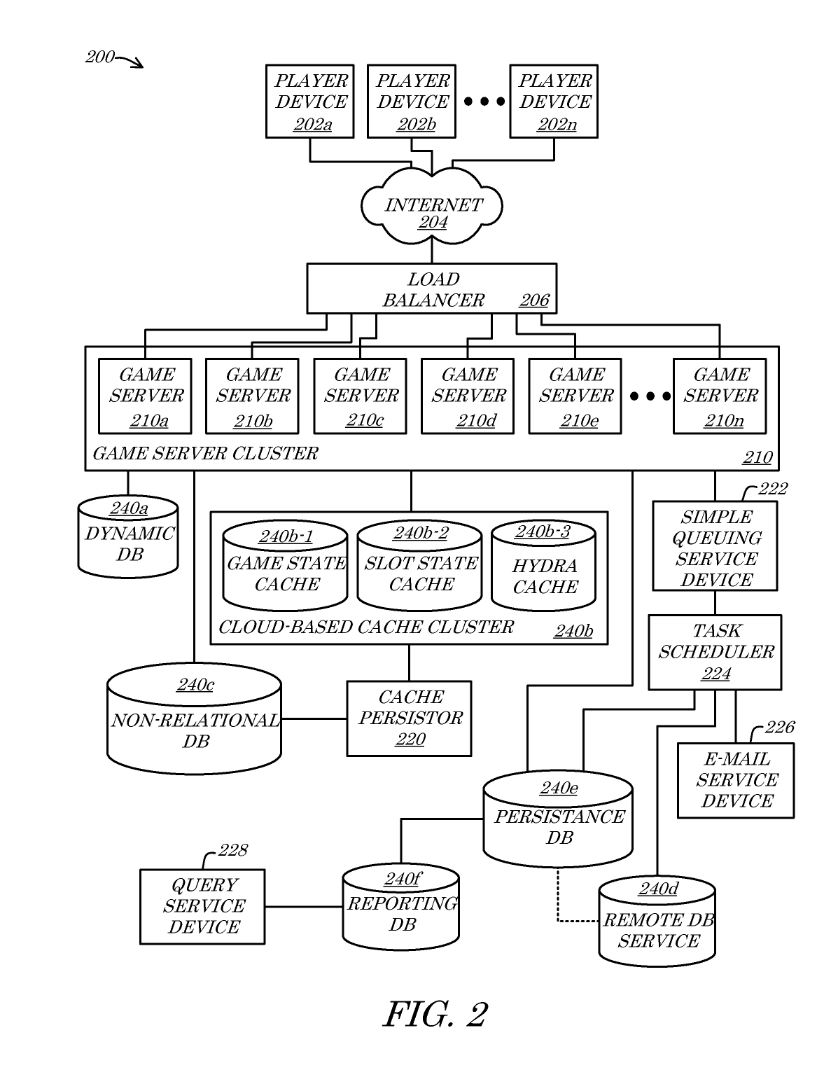

FIG. 2 a block diagram of an example system 200, which is consistent with some embodiments. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player device 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online bingo game (or tournament), a second game server 210c may host a second particular instance of an online bingo game (or tournament), a third game server 210c may facilitate an online poker tournament, and/or a fourth game server 210d may provide an online slots game.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., a reeled slots themed game) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

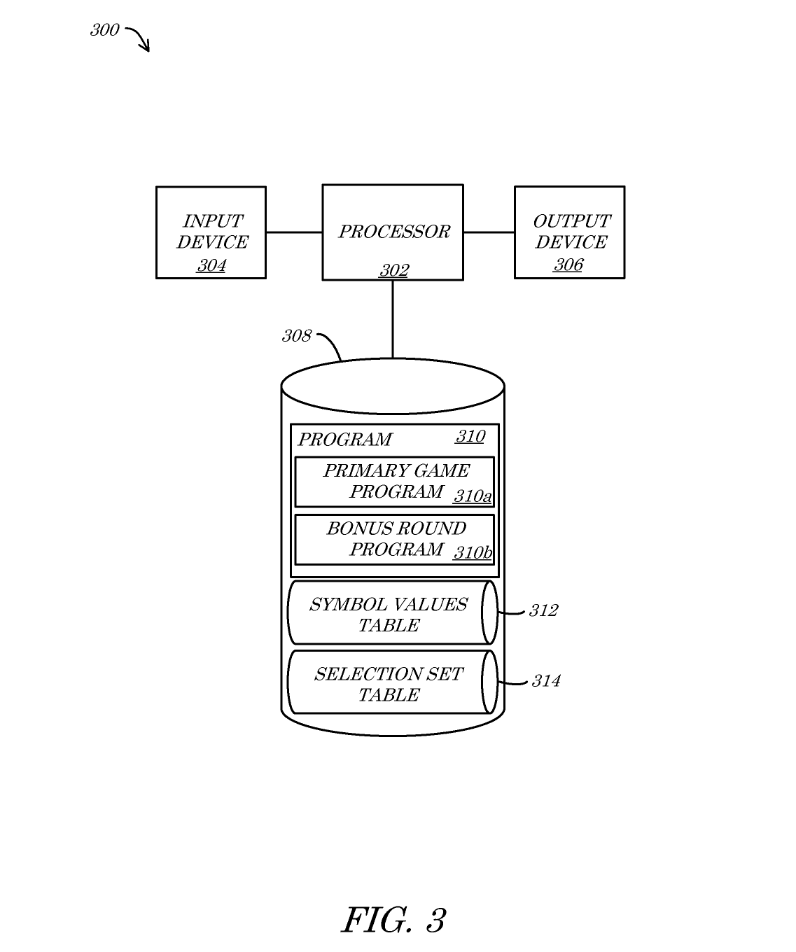

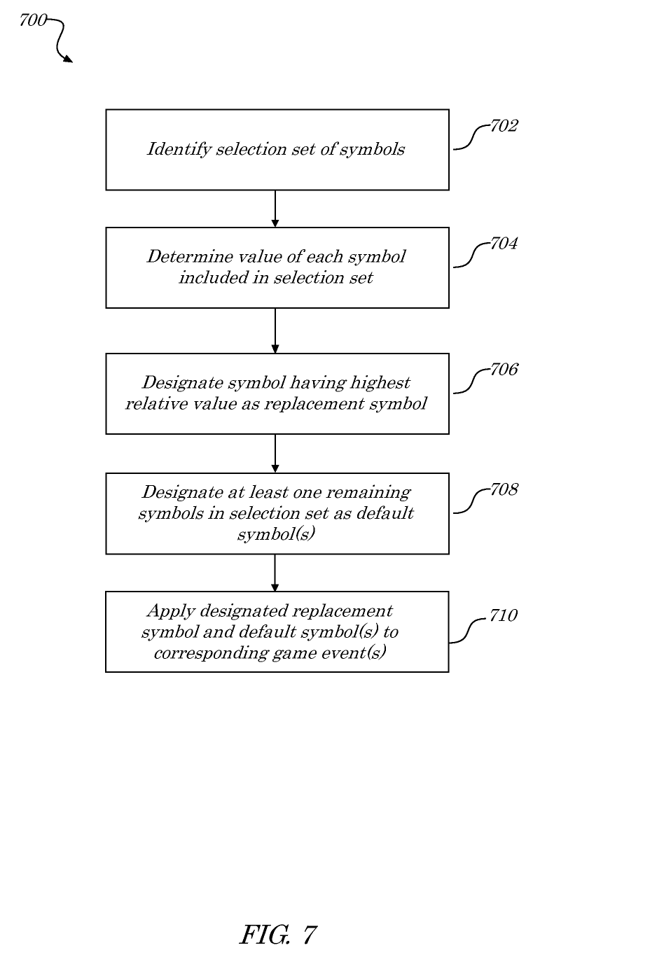

FIG. 3 is a block diagram of an apparatus 300 according to some embodiments. In some embodiments, the apparatus 300 may be similar in configuration and/or functionality to any of the player devices 102, the game server 110 and/or another server device operable to facilitate the embodiments described herein. The apparatus 300 may, for example, execute, process, facilitate, and/or otherwise be associated with any of the processes 700 and/or 800 described herein in conjunction with FIG. 7 and FIG. 8, respectively.

In some embodiments, the apparatus 300 may comprise a processor 302, an input device 304, an output device 306 and/or a memory device 308. Fewer or more components and/or various configurations of the components 302, 304, 306 and/or 308 may be included in the apparatus 300 without deviating from the scope of embodiments described herein.

According to some embodiments, the processor 302 may be or include any type, quantity, and/or configuration of processor that is or becomes known. The processor 302 may comprise, for example, an Intel® IXP 2800 network processor or an Intel® XEON™ Processor coupled with an Intel® E7501 chipset. In some embodiments, the processor 302 may comprise multiple inter-connected processors, microprocessors, and/or micro-engines. According to some embodiments, the processor 302 (and/or the apparatus 300 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 302 comprises a server such as a blade server, necessary power may be supplied via a standard AC outlet, power strip, surge protector, and/or Uninterruptible Power Supply (UPS) device.

In some embodiments, the input device 304 and/or the output device 306 are communicatively coupled to the processor 302 (e.g., via wired and/or wireless connections and/or pathways) and they may generally comprise any types or configurations of input and output components and/or devices that are or become known, respectively.

The input device 304 may comprise, for example, a keyboard that allows an operator of the apparatus 300 to interface with the apparatus 200 (e.g., by a player, an employee or other worker affiliated with either an online casino or other entity operating a system which provides games to players). In some embodiments, the input device 304 may comprise a mechanism configured to indicate to a remote server device an initiation or triggering of an event instance (e.g., that a player has actuated a “spin” mechanism and thus initiated a new spin or game instance of a reels-based game), such information being provided to the apparatus 300 and/or the processor 302. In such embodiments, the input device may comprise a key on a keyboard of the apparatus 300. Other examples of input devices include, but are not limited to: a game controller and/or gamepad, a bar-code scanner, a magnetic stripe reader, a pointing device (e.g., a computer mouse, touchpad, and/or trackball), a point-of-sale terminal keypad, a touch-screen, a microphone, an infrared sensor, a sonic ranger, a computer port, a video camera, a motion detector, a digital camera, a network card, a Universal Serial Bus (USB) port, a GPS receiver, a Radio Frequency Identification (RFID) receiver, a RF receiver, a thermometer, a pressure sensor, and a weight scale or mass balance.

The output device 306 may, according to some embodiments, comprise a display screen and/or other practicable output component and/or device that is operable to output information. The output device 306 may, for example, comprise a display screen via which are output outcomes, instructions, guidance, questions or information to a player of a game. For example, the output device may output a game interface for a bonus round which indicates an outcome of an event instance of the bonus round, such as the symbols populated into respective ones of a plurality of symbol positions comprising the game interface position, an indication that a symbol is a default symbol and has thus been replaced with a replacement symbol to create a revised outcome and/or any payouts or other awards won or earned by a player as a result of an outcome (e.g., a revised outcome) of the game. Some additional examples of output devices that may be useful in some embodiments include a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a data port. According to some embodiments, the input device 304 and/or the output device 306 may comprise and/or be embodied in a single device such as a touch-screen display or screen.

In some embodiments, the apparatus 300 may comprise any type or configuration of communication device (not shown) that is or becomes known or practicable. For example, the apparatus 300 may include a communication device such as a NIC, a telephonic device, a cellular network device, a router, a hub, a modem, and/or a communications port or cable. In some embodiments, the communication device may be coupled to provide data to a telecommunications device. The communication device may, for example, comprise a cellular telephone network transmission device that sends signals (e.g., an initiation of an event instance) to a server (e.g., game server 110) in communication with a plurality of player devices 102. According to some embodiments, the communication device may also or alternatively be coupled to the processor 302. In some embodiments, the communication device may comprise an IR, RF, Bluetooth™, and/or Wi-Fi® network device coupled to facilitate communications between the processor 202 and another device.

The memory device 308 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 308 may, according to some embodiments, store a program 310 for facilitating one or more of the embodiments described herein, which program may include a primary game program 310a for facilitating a primary aspect of a game (in some embodiments the program 310 may further include a bonus round program for facilitating a bonus round of the game, not shown). In some embodiments, the primary game program 310a and/or the bonus round program 310b (not shown) may be utilized by the processor 302 to provide output information via the output device 306.

The primary game program 310a may, for example, provide instructions for determining at least one of: (i) an outcome for the primary game responsive to a wager or other input from a player which initiates an event instance of the game (e.g., by requesting a random number from another server or device), (ii) which symbol positions (e.g., reel positions) should be populated with which symbols; (iii) determining, for each payline (or each active payline, depending on the embodiment being implemented) whether the outcome of the payline includes a winning combination and, if so, the payout or other award to provide to the player; (iv) increasing the credit balance of the player based on any payouts won as a result of the outcome; (v) a selection set for or more event instances (e.g., for use in all outcomes of a bonus round), which may include determining which symbol of the selection set is the replacement symbol (e.g., based on a respective value associated with each of the symbols comprising the selection set); (vi) replacing default symbol(s) with a replacement symbol to create a revised outcome; and/or (vii) re-evaluating each payline to determine whether the player has won any payouts as a result of the default symbol(s) being replaced with the replacement symbol.

The apparatus 300 may function as a computer terminal and/or server of an online casino or other entity operating to provide online games, receive and/or manage information related to online games. In some embodiments, the apparatus 300 may comprise a web server and/or other server device operable to accept wagers and determine random numbers based upon which outcomes for wagering games are determined. In some embodiments, the apparatus 300 may comprise an apparatus that is operable to interact with a player of an online game. In some embodiments, apparatus 300 may comprise a plurality of devices working together to accomplish the functionality described herein with respect to FIG. 3.

Any or all of the exemplary instructions and data types described herein and other practicable types of data may be stored in any number, type, and/or configuration of memory devices that is or becomes known. The memory device 308 may, for example, comprise one or more data tables or files, databases, table spaces, registers, and/or other storage structures. In some embodiments, multiple databases and/or storage structures (and/or multiple memory devices 308) may be utilized to store information associated with the apparatus 300. According to some embodiments, the memory device 308 may be incorporated into and/or otherwise coupled to the apparatus 300 (e.g., as shown) or may simply be accessible to the apparatus 200 (e.g., externally located and/or situated).

### Example Interfaces

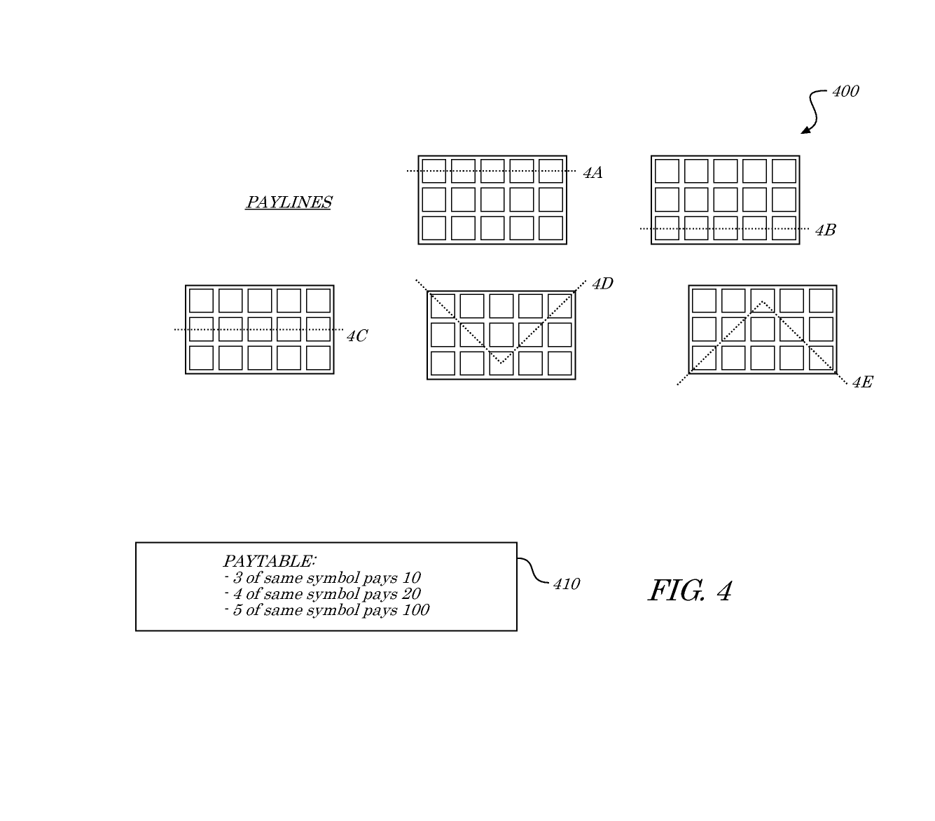

Turning now to FIG. 4, illustrated therein is an example game interfaces which embodies some embodiments described herein. In particular, FIG. 4 is a representation of the different paylines available in a game and the payout schedule for the game (e.g., winning combinations and the corresponding payout amounts). For example, a screen comprising the information of FIG. 4 (or similar information) may be output to a player who requests to see the paylines and payout schedule for the game. The paylines and payout schedule illustrated in FIG. 4 are utilized in the example embodiment illustrated via FIGS. 5A and 5B, as well as FIGS. 6A and 6B. Accordingly, FIG. 4 and the attendant description thereof will be referred to herein in the description of a progression of the game depicted in FIGS. 5A, 5B, 6A and 6B.

As illustrated in FIG. 4, there are five (5) paylines in the game, referred to as paylines 4A, 4B, 4C, 4D and 4E. The particular symbol positions of a symbol matrix which make up each respective payline are depicted as having a dotted line passing through them.

The game represented in the game interface of FIG. 4 (as well as the game interfaces of FIGS. 5A, 5B, 6A and 6B) consists of five vertical reels, with each reel having three symbol positions visible to a player of the game. Thus, the game used in FIGS. 4, 5A, 5B, 6A and 6B may be thought of as having a 3×5 symbol matrix (3 rows and 5 columns (reels)). In accordance with one embodiment, there are nine (9) possible paylines along which a winning combination of symbols may result in a payout or other prize being awarded to a player. Of course any number of reels and number of symbol positions on each reel or paylines may be utilized and the embodiments described herein are not dependent on any particular number or configuration of reels (or even a reel-based game), symbol positions in a symbol matrix or number or configuration of paylines.

For purposes of describing some embodiments, in the reel game interface of FIG. 4, FIGS. 5A through 5F and FIGS. 6A through 6B, the top visible symbol position of a given reel is referred to as position “0” herein, the middle visible symbol position of a given reel is referred to as position “1” herein and the bottom visible symbol position is referred to as position “2” herein. Thus, for example, payline 4A in FIG. 4 consists of position “0” on each of the five reels; payline 4B consists of position “2” on each of the five reels and payline 4C consists of position “1” on each of the five reels.

The example game depicted in FIGS. 4, 5A, 5B, 6A and 6B is an “A-B-C-D-E-F-G-H-I-J” themed game in which the available symbols are “A”, “B”, “C”, “D.” “E”, “F”, “G”, “I” and “J”. Area 410 of FIG. 4 indicates which combinations of symbols are considered winning combinations and the corresponding payout for each winning combination. For purposes of brevity, only a simplistic model of winning combinations is illustrated: (i) three (3) of the same regular symbol (or a combination of the same regular symbol and one or more wild symbols)) along a given payline will result in a payout or award of ten (10) credits being provided to the player (e.g., added to a credit meter balance associated with the player; (ii) four (4) of the same regular symbol (or a combination of the same regular symbol and one or more wild symbols) along a given payline will result in a payout of twenty (20) credits being provided to the player; and (iii) five (5) of the same regular symbol (or a combination of the same regular symbol and one or more wild symbols) will result in a payout of one-hundred (100) credits being provided to the player. The payline configurations 4A through 4E and payout table 410 will be referred to in the descriptions of FIGS. 6A and 6B.

Referring now to FIGS. 5A-5B, illustrated therein is an example of a game interface 500 as it may be modified over the course of play of a game (e.g., during an initial stage of a primary game or during an initial stage of a bonus round). In particular, FIG. 5A illustrates a representation of an example game interface as it may be output to a player upon initiation of a session of a primary game, an initiation of a bonus round, or during another time in a game when a player may select symbols for a selection set to be used in at least one game instance of the game (e.g., during the outcomes generated in a bonus round), prior to the replacement feature described herein being applied. As described herein, in some embodiments a player may be provided with an opportunity to select a plurality of symbols to comprise a selection set. The highest value symbol(s) of the selection set may be designated as the replacement symbol for use in the one or more game instances to which the selection set is to be applied, with the remaining symbol(s) of the selection set being designated at the default symbols. In other embodiments, the selection set may be selected for the player (e.g., randomly, by a processor facilitating the game). In some embodiments, the selection set selected by or for the player may be persistent (applied to) more than one game session or bonus round.

The game interface 500 includes an area 504 for outputting information about the game (e.g., about the replacement feature and instructions for selecting a plurality of symbols) to the player. In accordance with some embodiments, the values of the player selectable elements output to a player for selection are predetermined and stored prior to game interface comprising the selections being made available to the player. Thus, for example, the array of player selectable elements output in FIG. 5A may comprise respective selections which each conceal a predetermined and stored value (e.g., symbols of the game).

In the particular example of FIG. 5A, the player is instructed to select two of the player selectable elements 502a through 502l. Each of the player selectable elements 502a through 5021 may, for example, correspond to an area of a touch screen or other mechanism for accepting input from a player, which may be selected by the player via a touch or other input. In accordance with some embodiments, each of the question mark symbols depicted in FIG. 5A comprises a representation of a symbol, representing a respective player selectable element. Each player selectable element represents a hidden or concealed symbol which is one of the symbols available in the game (e.g., one of the symbols which will be a component of an outcome in the game). Once the player selects the particular player selectable elements of the player selectable elements 502a through 502l (and the player may pick two such player selectable elements in the example game represented in FIG. 5A), the symbol represented by the selected player selected elements may be revealed to the player. In accordance with some embodiments, the symbol selected by the player via the interface of FIG. 5A will comprise the selection set for use in the game. Area 506 of the game interface 500A informs the player that, in accordance with the rules of the example game represented in FIG. 5A, the highest value symbol selected by the player will replace the lower value symbol selected by the player (e.g., during the bonus round or during another aspect of the game to which the selection set it to b applied, as applicable).

In accordance with some embodiments, the player may be given actual control over selecting the symbols comprising the selection set. For example, all available symbols may be represented in the interface of player selectable elements (e.g., in an equal number). In some embodiments, certain symbols may be weighted such that they are more likely to be selected by the player (e.g., a certain symbol may be represented by a larger number of player selectable elements, such that it is more likely that the player will select that symbol). In some embodiments, not all symbols available in a game may be made available for inclusion in a selection set (e.g., the most valuable symbol(s) may be excluded, or may be excluded for certain players). In some embodiments, the symbols comprising a selection set may be predetermined and the player may merely be given an illusion of selecting the symbols (e.g., no matter which player selectable elements the player selects via an interface such as that of FIG. 5A, the symbols predetermined for the selection set may be revealed as the symbols “selected” by the player). In some embodiments, the player may not be provided with an opportunity to select symbols for inclusion in a selection set at all. Rather, the symbols comprising a selection set may be predetermined and output to the player (e.g., the symbols may be selected using a particular algorithm, may be selected using an RNG, etc.).

Turning now to FIG. 5B, illustrated therein is an illustration of the game interface of FIG. 5A after the symbols represented by the player selectable elements selected by the player are revealed to the player. In the example of FIG. 5B, the player selected player selectable element 502a (which is revealed to have represented symbol “A”) and player selectable element 502j (which is revealed to have represented symbol “D”). In accordance with some embodiments in which the player is provided an opportunity to select symbols for inclusion in a selection set, the value of each available symbol may be predetermined. Thus, once the player makes his selections, the symbols represented by the player selected player selectable elements may be determined and the corresponding value of each symbol may be ascertained (e.g., looked up in a table stored in a memory). For example, a table such as Table 2 above may be accessed and the value of each symbol in the selection set may be retrieved. Assuming, for illustrative purposes only, that Table 2 is accessed to determine the values of the symbols selected by the player in the present example, the symbol A (having a corresponding value of 4) is determined to be more valuable than the symbol D (having a corresponding value of 2). Thus, symbol A may (in accordance with some embodiments) be designated as the replacement symbol of the selection set and symbol D may be designated as the default symbol. As indicated to the player in area 506, in the bonus round following the selecting of the selection set (or, in other embodiments, in the other game instance(s) to which the selection set is to be applied), each time the symbol D appears it will be replaced by the more valuable symbol A.

In accordance with some embodiments, an interface of a game is output to a player in a certain aspect of the game (e.g., prior to the player entering a bonus round or upon the player qualifying for a bonus round). The game interface may comprise, for example, a matrix of all available symbols of the bonus round, output as available hidden or obscured “picks” to the player. The player selects a predetermined set of such “picks”, which are then revealed to the player. A value for each “pick” or selected symbol in the set of selected symbols is determined. During the bonus round (or some other predetermined span of the game), the highest valued symbol of the selection set picked by the player is used to replace any of the lower valued symbols in the selection set (the default symbols).

It should further be noted that “replacing” a default symbol with a replacement symbol may comprise any manner or methodology for causing a symbol position to indicate that it is now associated with a replacement symbol and usage of this term throughout the present description is not intended to limit the scope of the embodiments to a traditional “replacement” in which the default symbol is removed from the symbol position and a replacement symbol is placed in the symbol position in its stead. In some embodiments, for example, “replacing” a default symbol with a replacement symbol may comprise superimposing a semi-transparent image of a replacement symbol on the default symbol, placing a depiction of the replacement symbol near the default symbol in the symbol position and/or causing the symbol position to otherwise be designated as corresponding to a replacement symbol, such as by highlighting, shading, animating or otherwise altering the symbol position.

Turning now to FIG. 6A, illustrated therein is an example game interface 600A as it may be output to a player who is participating in a game session or game (or, in some embodiments, a bonus round of a game) in which the selection set identified via the game interfaces of FIGS. 5A and 5B is utilized. The example game illustrated is a reel-based game. In particular, FIG. 6A is an illustration of a screen shot which shows a “snapshot in time” of a current status of a game event (e.g., the bet placed, the symbols comprising the outcome, any payout won as a result of the outcome), such as it may appear to a player once the reels of the game interface stop spinning and the game event comprising the spin is resolved. For purposes of illustrating some embodiments, the game shown as progressing in FIGS. 6A through 6B is one for which the paylines and pay schedule of FIG. 4 is applied. It may be assumed, for purposes of the present example, that a maximum bet of 1.00 causes each of the available five (5) paylines to be active (i.e., to be evaluated for the presence of a winning combination of symbols and for a corresponding payout to be awarded to the player if such a winning combination is found).

The game interface 600A includes a plurality of areas for outputting information to a player. The areas include area 602, which is the symbol matrix comprising a plurality of symbol positions arranged in a configuration of five (5) columns (e.g., reels) and three (3) rows. Each intersection of a row and column comprises a unique symbol position (e.g., reel position “0” of the first reel on the left is a symbol position which in FIG. 6A has the symbol “A” positioned therein while reel symbol position “1” of the first reel on the left is a symbol position which in FIG. 6A has the symbol “D” placed therein). Area 604 of the screen interface outputs to the player (i) the total bet or wager being placed on the current game event; and (ii) the total win or payout won by the player as a result of the game event.

In the example of FIG. 6A, area 604 shown that a total bet of 1.00 (e.g., credits, dollars or another currency) has been placed on the current game event and that the player has won 10.00 credits as a result of the game event. A comparison to the paylines being utilized in the current game, illustrated in FIG. 4, shows that the symbols along payline 4D include three (3) “A” symbols and, in accordance with the paytable 410 of FIG. 4, an outcome with three (3) of the same symbols results in a payout of 10.00 credits to the player. In accordance with one embodiment, the payout for an outcome along a payline prior to any replacements of default symbols with replacement symbols (which outcome is referred to as an initial outcome herein), is provided to the player and reflected in the player's credit balance prior to the replacement step. In other embodiments, the payouts for any initial outcomes may not be output or provided to the player until after any default symbols are replaced with replacement symbols. The outcome which is created once the default symbol(s) are replaced with the replacement symbol is referred to as a revised outcome herein.

In some embodiments, replacing a default symbol with a replacement symbol may change a result of an outcome (e.g., an outcome along a particular payline). For example, replacing one or more default symbol(s) with a replacement symbol may cause an outcome of a payline to no longer be a winning outcome or to become an outcome which corresponds to a larger payout. For example, assuming the default symbol to be applied to the example outcome of FIG. 6A is “A” and the replacement symbol is “B” would cause the result of payline 4D, after the replacement step, to be a win of 20.00 credits (for the resulting revised outcome which includes four (4) “B” symbols) rather than 10.00 credits (for the initial outcome which includes three (3) “A” symbols). In accordance with some embodiments, a player may be provided with both a payout for an initial outcome and a payout for the revised outcome, if the initial outcome corresponds to a payout. In other embodiments, the player may be provided only with the payout corresponding to the revised outcome, even if an initial outcome corresponds to a payout. In still other embodiments, if an initial outcome corresponds a first payout and a revised outcome corresponds to a second payout, assuming the second payout is greater than the first payout the player may be provided only with the difference between the first payout and the second payout as a result of the revised outcome (or may not be provided with any payout if the second payout is less than the first payout).

Returning now to FIG. 6A, area 606 of the game interface 600A, if actuated or selected by the player, may in some embodiments cause a paytable and/or other information explaining the rules or mechanics of the game to be displayed to the player (e.g., via a new screen or pop-up window). For example, a selection of area 606 by a player may cause a screen similar to that depicted in FIG. 4 to be output to the player, informing the player of the paylines and payout schedule of the game.

It should be noted that the symbols to be output in the area 602 for an initial outcome of a game event may be determined based on a pseudo-random process. For example, a Random Number Generator (RNG) may be used to determine a random number which may then be used to determine the symbols to output in area 602. The RNG may be stored in, for example, a game server (e.g., game server 110 of FIG. 1), another server device in communication with a player device on which the game is being played or the player device itself. In some embodiments, the initiation of an event instance (e.g., a game event such as an initiation of a spin) or other request for an outcome of the game may cause the player device to request the outcome (or an RNG based upon which an outcome may be determined) from another device such as a game server (e.g., game server 110 of FIG. 1). Thus, in some embodiments when a player places a wager and initiates a game event (e.g., by actuating or selecting the “play” button or area 610, this may cause an outcome for the game event to be determined (e.g., which symbol should be placed in each symbol position of the game matrix to form an initial outcome) by at least one of the player device and a remote server device, based on an RNG process or another process.

Area 608 includes a selection of different bet amounts which a player may select for a given game event. For example, he player may choose to bet 0.25 (i.e., 25×0.01), 0.50 (i.e., 25×0.02), or 1.00 (i.e., 25×0.04). Of course, additional or different bet amounts may be used and the embodiments described herein are not limited to any particular bet amount or number of bet amounts.

Area 612 indicates to the player the current amount of the player's credit balance. In the current example, the player has 99.00 credits available for wagering from the credit balance. A bet the player places may be deduced from the credit balance shown in area 612 and any payouts won by the player may be added to the credit balance shown in area 612. Area 614 is an area for dynamically outputting messages to the player (e.g., messages of encouragement, status information and/or an explanation of a game event). For purposes of the present example, area 614 is outputting an indication of what the replacement symbol and the default symbol are for the current spin (the selection set to be applied to the initial outcome being displayed). Area 616 is yet another area for outputting information to a player, in particular for outputting payout information to the player. For purposes of the present example, area 606 is outputting a message indicating that the player has won 10.00 credits as a result of the initial outcome being displayed in area 602.

In the present application, like reference numerals in the Figures refer to like elements. Thus, for example, in the FIGS. 6A through 6B (which show a progression of game with first an initial outcome being output in FIG. 6A and then a revised outcome being output in FIG. 6B, based on a selection set determined via the example interfaces of FIGS. 5A and 5B), area 602 is repeated (although it may be shown to output different symbols in the symbol positions of the game matrix, showing the symbols comprising an initial outcome in FIG. 6A and showing the symbols comprising a revised outcome in FIG. 6B). Similarly, areas 604, 606, 608, 610 and 612 are also repeated, although the information or data shown in them may change (e.g., the credit balance shown in area 612 is adjusted based on game events).

It should be noted that additional information may be output to the player via the interface illustrated in FIGS. 6A through 6B, which additional information is omitted herein for purposes of brevity. For example, player history or preferences, information about other games the player is participating in, recommendations or tips for betting, etc. may be show for one or more players. In one embodiment, a selection set selected by or for the player may be persistent for the player over more than one game session and may be stored in association with a player identifier. In such embodiments, the selection set may be retrieved when a player initiates play of the game and may be output to the player via an area of the game interface.

Turning now to FIG. 6B, screen shot 600B (which shows the progress in the game of a player since that shown in FIG. 6A) illustrates that the “D” symbols in the initial outcome of FIG. 6A have been replaced with the replacement symbol “A” to create a revised outcome (the default symbol and the replacement symbol being the ones identified in FIG. 5B, for non-limiting and illustrative purposes only). The replacing of each of the “D” symbols with an “A” symbol has resulted in an additional win of 70.00 credits (as indicated in areas 604,614 and 616). Specifically, the revised outcome now includes the following winning outcomes and corresponding payouts: (i) three (3) “A” symbols along payline 4A, which corresponds to a payout of 10.00 credits; (ii) three (3) “A” symbols along payline 4B, which corresponds to another payout of 10.00 credits; (iii) three (3) “A” symbols along payline 4C, which corresponds to yet another payout of 10.00 credits; (iv) four “A” symbols along payline 4D, which corresponds to a payout of 20.00 credits; and (v) four “A” symbols along payline 4E, which corresponds to a payout of 20.00 credits.

Area 612 indicates that the player, after the creation of the revised outcome and the provision to the player of the payouts for both the initial outcome output in FIG. 6A and the revised outcome output in FIG. 6B, is 179.00 credits. In the embodiment of FIGS. 6A and 6B, the player is provided with both the full payout for the initial outcome and the full payout for the revised outcome (e.g., the player is provided 10.00 credits for the three “A” symbols along payline 4D in the initial outcome and the 20.00 credits for the four “A” symbols along payline 4D in the revised outcome). Although area 604 indicates a bet of 1.00, this is the bet the player placed on the spin which resulted in the initial outcome of FIG. 6A. In accordance with some embodiments, the player need not provide an additional bet for the revised outcome (although in other embodiments a bet for the revised outcome may be required or a higher bet for the initial outcome may be required in order to qualify to receive payouts for the revised outcome).

### Example Processes

Turning now to FIG. 7, illustrated therein is a processes 700 for implementing some of the embodiments described herein. The process 700 may comprise a process for implementing the replacement feature described herein, such as determining a selection set, determining which symbol of the selection set is a replacement symbol and which is/are default symbol(s) and applying the selection set to an initial outcome in order to create a revised outcome.

The processes 700 may be performed, for example, by at least one of a server device operable to facilitate an electronic (e.g., online) game and/or a player device enabling a player to play the electronic (e.g., online) game. For example, the processes 700 may be performed by at least one of (i) a player device 102 (FIG. 1); (ii) a game server 110 (FIG. 1); (iii) a player device 202 (FIG. 2); (iv) a game server 210 (FIG. 2); and (v) apparatus 300 (FIG. 3). It should be noted that additional and/or different steps may be added to those depicted and that not all steps depicted are necessary to any embodiment described herein. Rather, the process 700 is an example process of how some embodiments described herein may be implemented, and should not be taken in a limiting fashion. A person of ordinary skill in the art, upon contemplation of the embodiments described herein, may make various modifications to the process 700 without departing from the spirit and scope of the embodiments in the possession of applicants.

Turning now to FIG. 7, process 700 begins in step 702 with identifying a selection set of symbol. The selection set of symbols comprises a plurality of symbols from which at least one symbol will be designated as a replacement symbol and from which the remainder of the symbol(s) (all symbols which were not designated as the replacement symbol) will be designated as default symbols. In one embodiment, a selection set of symbols is utilized or applied in a particular set of game events (e.g., in all outcomes of a bonus round, upon the entry of which bonus round the selection set is identified). In one embodiment, the selection set of symbols is selected by a player. For example, a player may be prompted to select two or more symbols via an interface such as that illustrated in FIGS. 5A and 5B. In some embodiments, the player does not know the particular symbols he/she is selecting. For example, the player selects player selectable elements which conceal symbols and, once the player selects the player selectable elements, the symbols represented by the selected player selectable elements are revealed (e.g., as described with respect to the embodiment illustrated in FIGS. 5A and 5B). In one embodiment, the player is provided with actual control such that the selection set is not predetermined and the symbols comprising the selection set are actually selected by the player. In some embodiments, the set of symbols from which a player is allowed to select a selection set is not concealed (e.g., the player may know which symbols he/she is selecting as he/she is selecting them). In embodiments in which a selection set is selected by a player, step 702 may comprise receiving at least input from a player and identifying the symbols corresponding to the player input (e.g., determining the symbols corresponding to the player selectable elements selected by the player), thereby determining the selection set.

In another embodiment, the symbols comprising the selection set are predetermined (e.g., using an algorithm such as an RNG algorithm) and the player selection is merely a game mechanic which provides to the player an illusion of control (i.e., no matter which player selectable elements the player selects in an interface, the predetermined symbols comprising the selection set are revealed to the player). In such an embodiment, step 702 may comprise receiving an indication of the selection set from another device (e.g., a server utilizing an RNG or other algorithm for determining the selection set) and revealing the selection set to the player once the player selects the player selectable elements as being concealed by the player selectable elements the player selected.

In still another embodiment, the player is not provided an opportunity to select symbols or player selectable elements in order to determine a selection set. For example, a gaming device or game server (e.g., server 110 of FIG. 1) may be operable to determine a selection set based on an algorithm (e.g., an RNG algorithm). In one embodiment, a factor relevant to the player may be utilized to determine the selection set (e.g., a higher player rating of the player may result in a selection set comprising a higher valued symbol).

In one embodiment, step 702 (or another step in process 700 or a different process) may comprise selecting or determining the plurality of symbols from which a player may select the symbols to be included in the selection set. In some embodiments, all symbols of a game may be selectable by a player while in other embodiments only a subset of the symbols may be selectable by the player for inclusion in a selection set. In the latter embodiment, an algorithm may be used to determine the subset of symbols from which a selection set is selected. In some embodiments, the set of symbols from which a selection set may be selected (whether by the player or otherwise) may include more than one instance of a particular symbol (e.g., to make it more likely that a certain symbol will be selected for inclusion in the selection set, that symbol may be represented more than once in the set of symbols from which the selection set is selected). In some embodiments, selection of the subset of symbols may be weighted such that some symbols are more likely to be included in the subset or are more likely to be included more than once in the subset.

In one embodiment, one of the symbols of the selection set is designated as the replacement symbol. In accordance with one embodiment, the symbol corresponding the highest relative value (relative to the respective values of the other symbols in the selection set) is designated as the replacement symbol. Accordingly, in step 704 a value for each of the symbols comprising the selection set is determined. In some embodiments, a value may be determined dynamically based on a variety of factors. Examples of such factors include, without limitation, (i) data associated with the player (e.g., a rating of the player, an average bet of the player, bet history of the player, preferences of the player); and (ii) data associated with the game (e.g., previous outcomes determined in the game, a stage or status of the game, a probability or payout table being used for the game, a promotion associated with the game, whether the symbol is a symbol being collected in the game, etc.).

In other embodiments, each symbol available for selection into a selection set is pre-associated with a predetermined value. Such predetermined values may be determined based on a variety of factors which include, without limitation: (i) a number of winning outcomes which the symbol is a component of; (ii) a magnitude of payout(s) corresponding to winning outcomes of which the symbol is a component (e.g., an average of the payouts, a sum of the payouts, a median payout, etc.); (iii) a probability or frequency of occurrence of one or more payouts of which the symbol is a component; (iv) a secondary use for the symbol (e.g., is the symbol a collectible symbol, a symbol which qualifies the player for a bonus round or other benefit; is the symbol usable in another aspect of the game once it occurs in an outcome, etc.).

In one embodiment, determining a value for a symbol may comprise a hybrid approach of identifying a predetermined value pre-associated with the symbol and then determining whether to adjust or modify the predetermined value based on a context of the game or data associated with the player. For example, a predetermined value for a symbol may be increased if the symbol is a symbol being collected during the game (e.g., particularly if the player is particularly close to completing the collection).

In accordance with one embodiment, the value of a symbol may be represented as a numerical value. In other embodiment, the value may be represented in another format (e.g., a ranking, alphabetical order, etc.). The embodiments described herein is not dependent on any particular methodology or scheme for valuing symbols, so long as the relative values of different symbols may be determinable and function to allow a comparison of values of different symbols.

In accordance with one embodiment, a table or database may be stored in a memory of a device (e.g., a memory of game server 110 or a memory of a gaming device). The table may store each of the available symbols and a corresponding predetermined value for each symbol. An example of such a table is illustrated and described above with respect to Table 2.

One a value for each of the symbols in the selection set is determined, the values of the symbols are compared and the symbol corresponding to the highest value is designated as the replacement symbol (step 706). In accordance with one embodiment, the replacement symbol is the symbol which will replace at least one other symbol of the selection set once an initial outcome for a game event is determined and the default symbol(s) is determined to be a component of the initial outcome. For example, as illustrated in FIGS. 5A-5B, if the symbols “A” and “D” are selected and the values of Table 2 are utilized, symbol “A” is designated as a replacement symbol and replaces any “D” symbols in an initial outcome (as illustrated and described with respect to FIGS. 6A and 6D).

In some embodiments, there may be two or more symbols which are determined to have the same value, which may happen to be the highest value in a selection set. In one embodiment, in such a scenario only one symbol may be designated as the replacement symbol. The one symbol may be selected in accordance with any desired methodology. For example, one of the symbols may be selected randomly. In another example, the player may be allowed to “break the tie” and select the replacement symbol from the plurality of symbols having the same value. In yet another example, one or more predetermined factors or characteristics of a symbol other than its value may be considered in determining which value is to be designated as the replacement symbol. Some examples of such characteristics include, without limitation, whether the symbol in question (i) is a component of the most winning outcomes; (ii) is a component of a winning outcome corresponding to the highest payout; and/or (iii) any other factor deemed appropriate or desirable. In one embodiment, more than one symbol may be designated as a replacement symbol.

Once the replacement symbol is selected, at least one of the remaining symbol(s) of the selection set is designated as a default symbol(s). The default symbol(s) is/are the symbol(s) which will be replaced with the replacement symbols once an initial outcome is determined, thus creating a revised outcome. In accordance with one embodiment, if only two symbols comprise the selection set then the other symbol (the symbol which was not designated as the replacement symbol) is designated as the default symbol. In an embodiment in which the selection set comprises two or more other symbols (other than the symbol which was designated as the replacement symbol), then (i) the symbol corresponding to the lowest relative value may be designated as a default value; (ii) each of the remaining symbols may be designated as default symbols; or (iii) another methodology may be employed for selecting the symbol(s) of the selection as default symbol(s).

In embodiments in which only the symbol corresponding to the lowest relative value is designated as a default symbol, there may be two or more symbols which are determined to have the same value, which may happen to be the lowest value in a selection set. In one embodiment, in such a scenario only one symbol may be designated as the default symbol. The one symbol may be selected in accordance with any desired methodology. For example, one of the symbols may be selected randomly. In another example, the player may be allowed to “break the tie” and select the default symbol from the plurality of symbols having the same value. In yet another example, one or more predetermined factors or characteristics of a symbol other than its value may be considered in determining which value is to be designated as the default symbol. In one embodiment, more than one symbol may be designated as a default symbol.

In step 710, the designated replacement symbol(s) and the designated default symbol(s) are applied to the one or more game events for which they were determined (e.g., to the spins or other outcomes of a bonus round, such as to the free spins of a free spin bonus round, or to a session of a primary game).

In accordance with some embodiments, in a reeled slot machine type of game, after a player has selected his/her set of selection symbols for a game and the highest value symbol of the set of selection symbols has been identified for use in the game, a spin may be executed in a normal fashion until the reels are initially resolved. For example, once the player initiates a game play of the game and an outcome is determined for the game (not yet using the replacement methodology described herein), the reels may be allowed to initially resolve to show the outcome determined. The replacement process may then be initiated to show the player the replacement of any of the lower value symbols in the set with the highest value symbol. For example, in accordance with some embodiments, after any default symbols on one or more reels are replaced with replacement symbols, the paylines of the game are re-evaluated for the current spin to determine whether any new or additional winning combinations have been created along the paylines as a result of the replacing. In some embodiments, only the paylines the player bet on when initiating the spin (i.e., the “active” paylines for the spin) may be evaluated in the re-evaluating step after the replacement of any default symbols with the replacement symbol. In other embodiments, all paylines may be evaluated for winning combinations after the replacing step.

In other embodiments, the replacement process may occur prior to the reels resolving, such that the replacement may not be visible to the player playing the game. For example, an outcome may be determined for a game event after the player has selected his selection set of symbols for the game and, prior to resolving the reels such that the determined outcome is output along a payline of the game, any default symbols of the set are replaced with the replacement symbol. In such embodiments, the reels may resolve only after the replacement process is completed.

### Example Implementation:

A player selects from an unknown series of symbols 2 or more symbols. The symbols picked are all replaced on the reels by the highest symbol picked by the player. This can happen as part of any base game spin as an instant feature or as the entry to a free spins bonus.

For example, consider a symbol paytable which includes outcomes comprised of symbols A, B, C, D, E, F, with A being the highest value symbol and F being the lowest+W(Wild).

In a first embodiment, on any given spin (during or after the spin lands) an interface feature presents the player with a selection process. The player picks a number of symbols. Assume a player is allowed to pick 2 symbols. Assume further the player's first pick turns out (once it is revealed to the player) to be B and the player's second pick turns out to be F. The F symbols on the reels now become B symbols for win evaluations on that and potentially a number of subsequent spins.

In a second embodiment, the replacement feature may be triggered once a player qualifies for a bonus round (e.g., a free spins bonus). On entry to free spins the player makes a selection, this selection reveals a number. In this case 4 (other values displayed include 2, 3, and 5). The player is then prompted to pick from a grid of unknown symbols. The player picks D first, then C, then F. At this point all D and F symbols would be evaluated as C; the player has one pick left and is lucky enough to pick W. Thus, the symbols C, D and F symbols will be default symbols that will be replaced with Wild symbols for the duration of the free spins feature of the game.

In accordance with some embodiments, a player may be allowed to accept/reject a selection set of symbols picked by the player. For example, the player can choose to reject an offered symbol combination and hope for a better combination of symbols in another round of picking (e.g., the player may be allowed three attempts to pick a selection set the player is satisfied with).

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE INC, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A system for facilitating a game, the system comprising:
a processor;
a memory storing a program for controlling the processor, the processor being operable with the program to:
determine a plurality of symbols selected for use in at least one game event;
identify a symbol of the plurality of symbols which corresponds to a highest relative value, thereby determining a replacement symbol;
designate as a default symbol at least one symbol of the plurality of symbols which is not the replacement symbol;
determine an initial outcome for the at least one game event;
determine that the initial outcome include at least one default symbol; and
replace with the replacement symbol each of the at least one default symbols, thereby creating a revised outcome.

2. The system of claim 1, wherein the processor being operable with the program to designate as the default symbol at least one symbol of the plurality of symbols which is not the replacement symbol comprises the processor being operable with the program to:
designate as the default symbol the symbol of the plurality of symbols which corresponds to a lowest relative value.

3. The system of claim 1, wherein the processor being operable with the program to designate as the default symbol at least one symbol of the plurality of symbols which is not the replacement symbol comprises the processor being operable with the program to:
designate as a default symbol each of the symbols of the plurality of symbols which is not the replacement symbol.

4. The system of claim 1, wherein the plurality of symbols is determined based on at least one selection by a player associated with the game event.

5. The system of claim 4, wherein the processor is further operable with the program to:
output to the player a plurality of player selectable elements, each player selectable element of the plurality of player selectable elements representing a respective symbol; and
receive at least one input from the player, the at least one input indicating a plurality of the player selectable elements.

6. The system of claim 5, wherein the processor is further operable with the program to:
determine the respective symbols represented by each player selectable element of the plurality of player selectable elements, thereby determining the plurality of symbols selected by the player.

7. The system of claim 6, wherein the processor is further operable with the program to:
determine the plurality of symbols as having been predetermined for the at least one game event by at least one of the processor and a second processor; and
output to the player the plurality of symbols as a result of the at least one input.

8. The system of claim 1, wherein the plurality of symbols is selected by at least one of the processor and a second processor.

9. The system of claim 1, wherein the processor is further operable with the program to:
determine, prior to identifying the symbol which corresponds to the highest relative value and for each symbol of the plurality of symbols, a corresponding value.

10. The system of claim 9, wherein the processor is operable with the program to determine, for each symbol of the plurality of symbols, the corresponding value by:
retrieving, for each symbol of the plurality of symbols, the corresponding value from a table which stores, for each of the plurality of symbols, a respective predetermined value.

11. The system of claim 9, wherein the processor is operable with the program to determine, for each symbol of the plurality of symbols, the corresponding value by:
determining at least one of first data associated with a player associated with the game event and second data associated with the at least one game event; and
determining, for each symbol of the plurality of symbols, the corresponding value based on at least one of the first data and second data.

12. The system of claim 1, wherein the processor is further operable with the program to:
output, to a player associated with the at least one game event, an indication of the initial outcome.

13. The system of claim 12, wherein the processor is further operable with the program to:
authorize a provision, to the player, of a first payout associated with the initial outcome.

14. The system of claim 13, wherein the processor is further operable with the program to:
determine that the revised outcome is associated with a second payout; and
authorize a provision, to the player, of an amount based on the second payout.

15. The system of claim 14, wherein the amount is the second payout.

16. The system of claim 14, wherein the amount is the second payout minus the first payout.

17. A non-transitory computer readable medium storing instructions for directing a processor, the instructions when executed by the processor causing the processor to:
determine a plurality of symbols selected for use in at least one game event;
identify a symbol of the plurality of symbols which corresponds to a highest relative value, thereby determining a replacement symbol;
designate as a default symbol at least one symbol of the plurality of symbols which is not the replacement symbol;
determine an initial outcome for the at least one game event;
determine that the initial outcome include at least one default symbol; and
replace with the replacement symbol each of the at least one default symbols, thereby creating a revised outcome.

18. A method for facilitating a game, the method comprising:
identifying, by a processor of a computing device, at least one replacement symbol for use in at least one game event;
identifying, by the processor, at least one default symbol to be replaced by the replacement symbol in the at least one game event;
determining, by the processor, an initial outcome for the game event;
determining, by the processor, that the initial outcome includes the at least one default symbol;
causing, by the processor, the at least one default symbol to be replaced with the replacement symbol, thereby creating a revised outcome; and
authorizing, by the processor, any payout which may correspond to the revised outcome to be provided.
